(19) United States
(12) Patent Application Publication
(10) Pub. No.: US 2018/0279078 A1
(43) Pub. Date: Sep. 27, 2018

(54) CONFIRMING WORK SUPPORTING DEVICE, CONFIRMING WORK SUPPORTING SYSTEM, AND COMPUTER PROGRAM PRODUCT

(71) Applicant: KABUSHIKI KAISHA TOSHIBA, Tokyo (JP)

(72) Inventors: Yuki YONEZAWA, Ayase (JP); Cam Ly NGUYEN, Yokohama (JP); Takafumi SAKAMOTO, Tokyo (JP); Masaki MUKAMOTO, Kawasaki (JP); Mitsuru KANDA, Tokyo (JP)

(21) Appl. No.: 15/690,798

(22) Filed: Aug. 30, 2017

(30) Foreign Application Priority Data
Mar. 21, 2017 (JP) 2017-053904

(51) Int. Cl. H04W 4/02; H04B 17/318; H04B 17/27; G06Q 10/04

(52) U.S. Cl. CPC H04W 4/023; G06Q 10/047; H04B 17/27; H04B 17/318

(57) ABSTRACT

According to an embodiment, a confirming work supporting device includes a storage and processing circuitry. The storage is configured to store therein RSSI (Received Signal Strength Indicator) information that indicates reception strength of a wireless signal as measured by each of a plurality of installed wireless devices, from another wireless device. The processing circuitry is configured to determine, based on the RSSI information, a confirming order in which positions of the plurality of wireless devices are to be confirmed, and output, based on the confirming order, instruction information for an instruction to confirm a positon of a wireless device whose position is to be confirmed next.

### CROSS-REFERENCE TO RELATED APPLICATIONS

This application is based upon and claims the benefit of priority from Japanese Patent Application No. 2017-053904, filed on Mar. 21, 2017; the entire contents of which are incorporated herein by reference.

### FIELD

Embodiments described herein relate generally to a confirming work supporting device, a confirming work supporting system, and a computer program product.

### BACKGROUND

In recent years, with the progress of the wireless communication technology, the wireless communication function is provided also in, for example, building-associated equipment such as lighting devices and air-conditioning devices. In this written description, such devices having the wireless communication function are called “wireless devices”. The operations of a wireless device can be controlled by wirelessly sending a control instruction in which the target wireless device for control is specified using identification information (a device ID) thereof.

If a plurality of wireless devices, which is difficult to differentiate from each other from their external appearances, is installed in a predetermined area; in order to properly control the operations of the wireless device installed at the desired position by performing wireless transmission of a control instruction mentioned above, it is necessary to have information about the wireless device installed at each of a plurality of device installation positions (positions of installed wireless devices) within the predetermined area. That is, it is necessary to know the correspondence relationship of a plurality of device installation positions with a plurality of wireless devices, and it is necessary to identify the wireless device at the desired position as the target for control according to the correspondence relationship. Moreover, also for the purpose of properly managing a plurality of wireless devices (for example, keeping track of the operation history, keeping track of the power consumption, and keeping track of the history of replacement of consumables), it is important to know the correspondence relationship of a plurality of device installation positions with a plurality of wireless devices.

Conventionally, a technology has been proposed for estimating the positions of the wireless devices using information such as the reception strength (RSSI: Received Signal Strength Indicator) measured by the wireless devices. Using such a technology for estimating the positions of the wireless devices, the correspondence relationship of a plurality of device installation positions with a plurality of wireless devices within a predetermined area can be estimated with a certain level of accuracy. However, since the correspondence relationship estimated in that manner is not always accurate, the reality is that a worker confirms which wireless device is installed at which device installation position and obtains an accurate correspondence relationship. Besides, the procedure for the work of confirming the positions of the wireless devices is not particularly fixed, and is carried out based on the independent judgement of the worker. For that reason, often the work cannot be carried out with efficiency. Hence, there is a demand for enabling efficient implementation of the work of confirm the positions of the wireless devices.

### BRIEF DESCRIPTION OF THE DRAWINGS

FIG. 1 is a block diagram illustrating an exemplary functional configuration of a confirming work supporting device;

FIG. 2 is a block diagram illustrating an exemplary hardware configuration of the confirming work supporting device;

FIGS. 3A and 3B are diagrams illustrating an example of area information;

FIG. 4 is a diagram illustrating an example of reception strength information;

FIG. 5 is a diagram illustrating an exemplary estimation result of correspondence relationship;

FIG. 6 is a diagram illustrating an exemplary travelling path;

FIG. 7 is a diagram illustrating an exemplary confirming order list;

FIGS. 8 to 10 are diagrams illustrating examples of a display image;

FIG. 11 is a diagram for explaining the distance of movement of a worker;

FIG. 12 is a flowchart for explaining an exemplary sequence of operations performed by the confirming work supporting device;

FIG. 13 is a block diagram illustrating an overview of a confirming work supporting system;

FIGS. 14A and 14B are diagrams illustrating an example of the area information;

FIGS. 15A and 15B are diagrams illustrating an example of the reception strength information and measurement count information;

FIG. 16 is a diagram for explaining an example of grouping performed according to the graph partitioning method;

FIGS. 17A and 17B are diagrams illustrating an example of confirming order lists;

FIG. 18 is a diagram illustrating an example of the display image;

FIG. 19 is a diagram illustrating an example of an estimation result display image;

FIG. 20 is a block diagram illustrating an exemplary functional configuration of the confirming work supporting device; and

FIGS. 21 and 22 are diagrams illustrating examples of the display image.

### DETAILED DESCRIPTION

According to an embodiment, a confirming work supporting device includes a storage and processing circuitry. The storage is configured to store therein RSSI (Received Signal Strength Indicator) information that indicates reception strength of a wireless signal as measured by each of a plurality of installed wireless devices, from another wireless device. The processing circuitry is configured to determine, based on the RSSI information, a confirming order in which positions of the plurality of wireless devices are to be confirmed, and output, based on the confirming order, instruction information for an instruction to confirm a positon of a wireless device whose position is to be confirmed next.

Exemplary embodiments of the invention are for supporting efficient implementation of the work of confirming the positions of a plurality of wireless devices installed in a predetermined area. Herein, lighting devices having the wireless communication function are considered as an example of the wireless devices. When a plurality of lighting devices is installed at a plurality of device installation positions in a predetermined area, since the lighting devices are difficult to differentiate from each other from their external appearances, the device installation positions of the lighting devices are not known. In such a situation, in order to get to know the correspondence relationship of a plurality of device installation positions with a plurality of lighting devices, a worker actually does the rounds of the predetermined area and performs the work of operating individual lighting devices so as to confirm their positions. The embodiments of the invention support efficient implementation of the work of confirming the positions of wireless devices such as the lighting devices.

Exemplary embodiments of a confirming work supporting device, a confirming work supporting system, and a computer program product are described below in detail with reference to the accompanying drawings. In the following explanation, the constituent elements having identical functions are referred to by the same reference numerals, and the redundant explanation is not repeated.

### First Embodiment

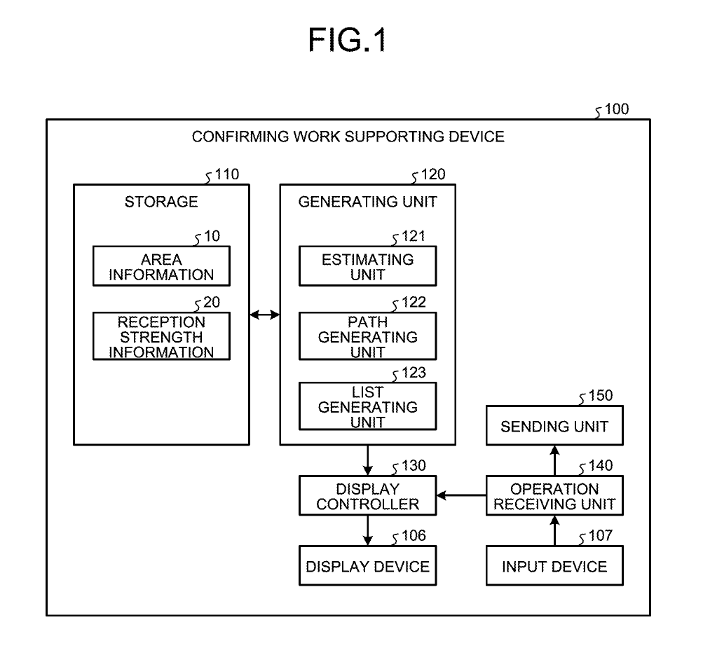

FIG. 1 is a block diagram illustrating an exemplary functional configuration of a confirming work supporting device 100 according to a first embodiment. As the functional constituent elements, the confirming work supporting device 100 includes a storage 110, a generating unit 120 (a determiner), a display controller 130, an operation receiving unit 140, and a sending unit 150 as illustrated in FIG. 1, for example. The generating unit 120 and the display controller 130 can constitute a controller. The abovementioned constituent elements can be implemented using the cooperation between hardware, which constitutes a general-purpose computer, and computer programs (software), which are executed in the computer. For example, one or more processors execute predetermined computer programs using a memory and implement the processing units such as the generating unit 120, the display controller 130, the operation receiving unit 140, and the sending unit 150. Moreover, a storage device of the computer can be used to implement the storage 110.

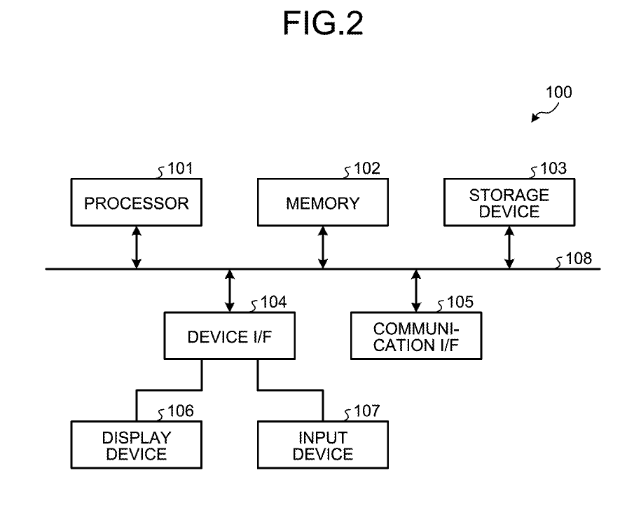

FIG. 2 is a block diagram illustrating an exemplary hardware configuration of the confirming work supporting device 100 according to the first embodiment. The confirming work supporting device 100 has the hardware configuration of a normal computer that includes a processor 101 such as a central processing unit (CPU); a memory 102 such as a random access memory (RAM) or a read only memory (ROM); a storage device 103 such as a hard disk drive (HDD) or a solid state drive (SSD); a device interface (I/F) 104 that enables connection to a display device 106 such as a liquid crystal panel and an input device 107 such as a keyboard, a mouse, or a touch-sensitive panel; a communication I/F 105 that performs communication with the outside of the device; and a bus 108 that connects the constituent elements to each other as illustrated in FIG. 2, for example.

In the case in which the confirming work supporting device 100 has the hardware configuration as illustrated in FIG. 2; for example, the processor 101 reads the computer programs from the storage device 103 into the memory 102 and executes them so that the generating unit 120, the display controller 130, the operation receiving unit 140, and the sending unit 150 are implemented. Meanwhile, the storage 110 can be implemented using the storage device 103. Meanwhile, the display controller 130 uses the device I/F 104 for displaying a display image (described later) on the display controller 130. The operation receiving unit 140 uses the device I/F 104 for receiving user operations performed using the input device 107. The sending unit 150 uses the communication I/F 105 for sending control instructions to the wireless devices.

The computer programs executed by the processor 101 are, for example, recorded in a recording medium such as a magnetic disk, an optical disk, or a semiconductor memory and are then stored in the storage device 103. As long as the recording medium for recording the computer programs is a computer-readable recording medium, any arbitrary memory format can be used. Alternatively, the computer programs can be installed in advance in the computer, or can be distributed via a network and installed in the computer.

Meanwhile, some or all of the processing units of the confirming work supporting device 100 according to the first embodiment can be implemented using dedicated hardware (not a general-purpose processor but a dedicated processor) such as an application specific integrated circuit (ASIC) or a field-programmable gate array (FPGA). Alternatively, the processing units can be implemented using a plurality of processors.

The storage 110 is used to store at least area information 10 and reception strength information 20. The area information 10 and the reception strength information 20 either can be stored in advance in the storage 110 or can be obtained from outside in response to a user operation of, for example, a worker and then stored in the storage 110. In the case of obtaining the area information 10 and the reception strength information 20 from outside; for example, an external device that is connected to a network can be accessed via the communication I/F 105 and the area information 10 and the reception strength information 20 held in the external device can be obtained via the network.

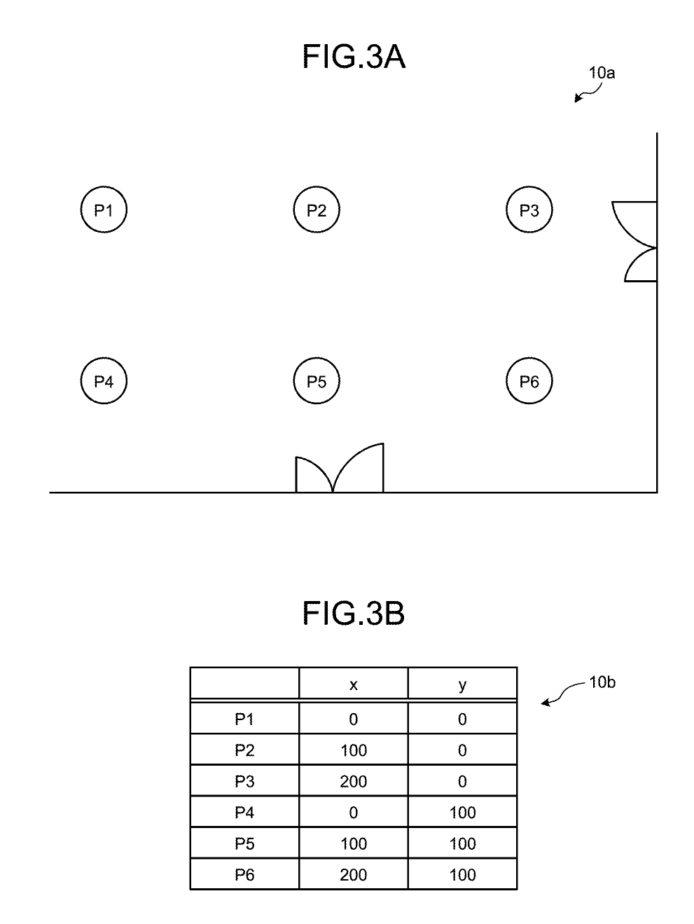

The area information 10 contains, for example, drawing data of the predetermined area and a position information table indicating position information of each of a plurality of device installation positions in the predetermined area. An example of the area information 10 is illustrated in FIGS. 3A and 3B. In FIG. 3A is illustrated an example of drawing data 10a of the predetermined area that includes six device installation positions P1 to P6, and in FIG. 3B is illustrated an example of a position information table 10b indicating the position information of the six device installation positions P1 to P6. Herein, the position information of the six device installation positions P1 to P6 is given in the form of relative coordinate values with the device installation position P1 serving as the base point. However, that is not the only possible case. As long as the position information enables identification of the device installation positions in the predetermined area, it can be expressed either as relative values or as absolute values with reference to an arbitrary base point in the predetermined area. Meanwhile, as long as the area information 10 at least contains the position information of a plurality of device installation positions, it need not contain the drawing data 10a and can also contain other information related to the predetermined area.

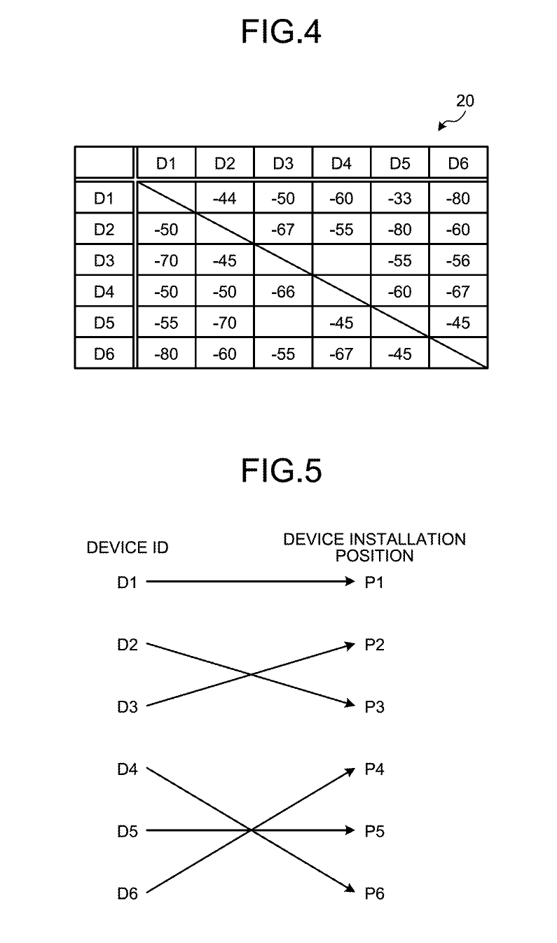

The reception strength information 20 is information indicating the reception strength of wireless signals, which are received from other wireless devices, as measured by each of a plurality of wireless devices installed in the predetermined area. An example of the reception strength information 20 is illustrated in FIG. 4. The reception strength information 20 illustrated in FIG. 4 is expressed as a matrix of the reception strengths with other wireless devices as measured by each of six wireless devices D1 to D6 (herein, D1 to D6 represent device IDs of the wireless devices) that is installed at one of the six device installation positions P1 to P6 in the predetermined area. The reception strength is expressed as a negative value (having dB as the unit), and becomes higher as the value thereof moves closer to zero. In the position information table, blank spaces indicate that the reception strength could not be measured. Meanwhile, the reception strength information 20 is not limited to have the tabular form illustrated in FIG. 4, and can have any arbitrary format.

The generating unit 120 is a functional module that, based on the reception strength information 20 stored in the storage 110, determines the order in which the positions of a plurality of wireless devices installed in the predetermined area are to be confirmed. For example, the generating unit 120 determines the order in which the positions of a plurality of wireless devices are to be confirmed and generates a confirming order list (described later). For example, as illustrated in FIG. 1, the generating unit 120 includes an estimating unit 121, a path generating unit 122, and a list generating unit 123.

The estimating unit 121 estimates, based on the area information 10 and the reception strength information 20 stored in the storage 110, the correspondence relationship of a plurality of device installation positions in the predetermined area with a plurality of wireless devices installed in the predetermined area. The reception strength measured by a particular wireless device is dependent on the distance to the wireless device that transmitted radio waves. In the first embodiment, since each of a plurality of wireless devices is installed at one of a plurality of device installation positions in the predetermined area, the correspondence relationship of a plurality of device installation positions with a plurality of wireless devices can be estimated based on the area information 10 providing the distance between any two device installation positions and based on the reception strength information 20 providing the reception strength between any two wireless devices.

For example, based on the distance between two device installation positions, it is possible to predict the reception strength between the two wireless devices that are installed at those two device installation positions. Herein, if it is assumed that arbitrary two wireless devices from among a plurality of wireless devices are installed at the concerned device installation positions; then, from the difference between the predicted reception strength (a predicated value) and the actual reception strength (the measured value) obtained from the reception strength information 20, it becomes possible to obtain the degree of inconsistency in the correspondence relationship of the two concerned device installation positions with the two concerned wireless devices. Then, regarding a plurality of device installation positions in the predetermined area and a plurality of wireless devices, the degree of inconsistency in the correspondence relationship of each combination of two device installation positions and two wireless devices can be obtained, and the set of combinations having the smallest sum of the degrees of inconsistency can be estimated as the correspondence relationship of a plurality of device installation positions with a plurality of wireless devices. Regarding a specific example of the method of estimating the correspondence relationship, the details are explained later.

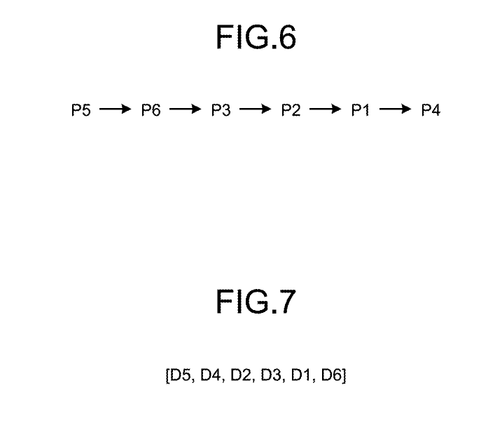

In FIG. 5 is illustrated an example of the result of estimating the correspondence relationship of a plurality of device installation positions with a plurality of wireless devices as obtained by the estimating unit 121. The example illustrated in FIG. 5 is an exemplary estimation result of the correspondence relationship as estimated by the estimating unit 121 based on the area information 10 illustrated in FIGS. 3A and 3B and the reception strength information 20 illustrated in FIG. 4. The correspondence relationship of the device installation positions with a plurality of wireless devices as estimated by the estimating unit 121 is not necessarily the correct correspondence relationship. However, the relative positional relationship between the wireless devices (for example, the relationship between neighboring wireless devices) has a comparatively higher accuracy.

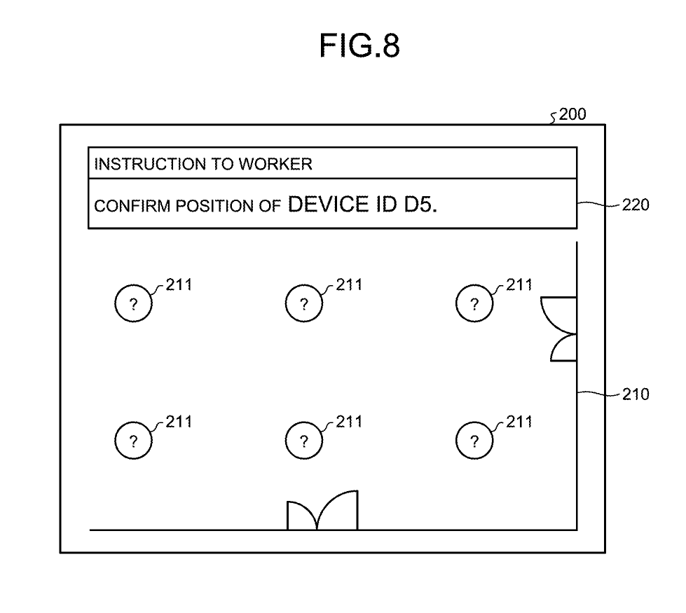

The path generating unit 122 generates, based on the area information 10 stored in the storage 110, a travelling path for efficiently doing the rounds of a plurality of device installation positions in the predetermined area. The path generating unit 122 can generate the travelling path using a known path generation technology such as the optimization algorithm of the travelling salesman problem. In FIG. 6 is illustrated an exemplary travelling path generated by the path travelling unit 122. Regarding the start position of the travelling path, for example, the positions of the doorways of the predetermined area can be figured out from the drawing data and either the device installation position closest to a doorway can be set as the start position of the travelling path or a random position can be set as the start position of the travelling path. Alternatively, position information indicating the current position of the worker (i.e., the position information of the confirming work supporting device 100) can be separately obtained, and the device installation position closest to the current position of the worker can be set as the start position of the travelling path.

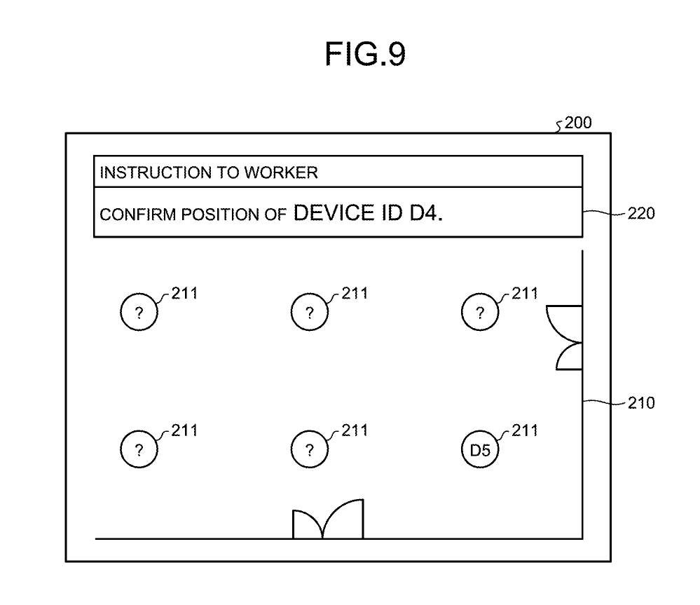

The list generating unit 123 determines, based on the correspondence relationship of a plurality of device installation positions with a plurality of wireless devices as estimated by the estimating unit 121 and based on the travelling path generated by the path generating unit 122, the order in which the positions of a plurality of wireless devices are to be confirmed and generates a confirming order list in which the device IDs of the wireless devices are arranged according to the order of position confirmation. In FIG. 7 is illustrated an example of the confirming order list generated by the list generating unit 123. The exemplary confirming order list illustrated in FIG. 7 is generated based on the estimation result of the correspondence relationship as illustrated in FIG. 5 and based on the travelling path illustrated in FIG. 6; and indicates that the positions of the wireless devices are to be confirmed in the order of the wireless device having the device ID D5, the wireless device having the device ID D4, the wireless device having the device ID D2, the wireless device having the device ID D3, the wireless device having the device ID D1, and the wireless device having the device ID D6.

Based on the confirming order list generated by the list generating unit 123, the display controller 130 decides on the wireless device whose position needs to be confirmed next from among a plurality of wireless devices installed in the predetermined area, and outputs instruction information for the instruction to confirm the position of that wireless device. For example, the display controller 130 displays, on the display device 106, a display image that includes the instruction information. A specific example of the display image is explained later in detail. Meanwhile, the wireless device for which the instruction to confirm the position is made in the first place from among a plurality of wireless devices need not be the initial wireless device in the confirming order list. In that case, the wireless device whose position confirmation is to be performed next can be sequentially decided in such a way that, after the position confirmation of the last wireless device in the confirming order list is finished, the position confirmation of initial wireless device in the confirming order list is performed.

The operation receiving unit 140 receives a user operation, which is performed by a worker using the input device 107, with respect to the display image displayed on the display device 106 by the display controller 130. Herein, it is assumed that a liquid crystal panel is used as the display device 106, and a touch-sensitive panel placed in an overlapping manner on the liquid crystal panel is used as the input device 107. In that case, when a worker performs a user operation of tapping a predetermined position on the display image displayed on the display device 106, the operation receiving unit 140 receives that user operation.

In response to a user operation with respect to the display image displayed on the display device 106 by the display controller 130, the sending unit 150 issues a control instruction for operating a wireless device, to the wireless device for which the instruction to confirm the position is made with the instruction information. For example, when the operation receiving unit 140 receives a user operation in which a worker taps the display area of the instruction information in the display image; the sending unit 150 treats, as the destination, the device ID of the wireless device for which the instruction to confirm the position is made with the instruction information, and generates and wirelessly issues a control instruction including a command to switch the wireless device to a predetermined operating state (in the case of a lighting device, lighting up for a predetermined period of time).

Explained below with reference to a specific example of display images, which are displayed on the display device 106, is the image transition of the display images in response to the operations performed by the operation receiving unit 140 and the sending unit 150.

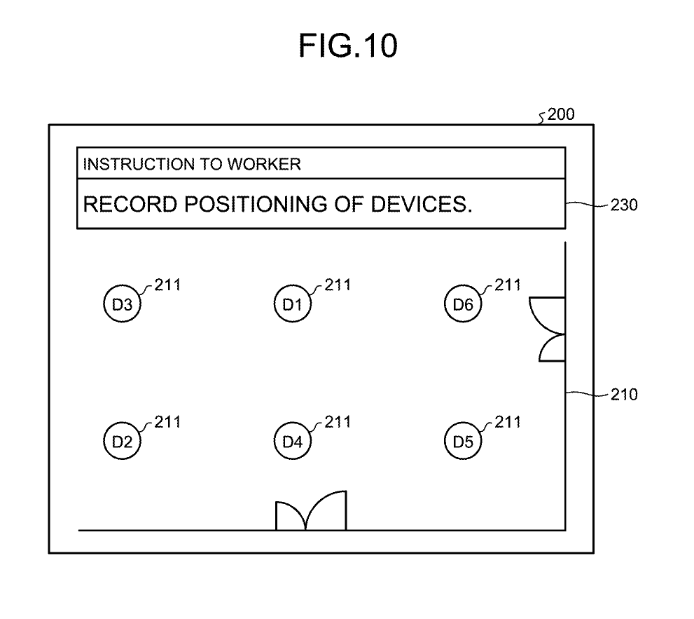

FIGS. 8 to 10 are diagrams illustrating examples of a display image 200 that is displayed on the display device 106. In FIG. 8 is illustrated an example of the display image 200 that is displayed at the beginning on the display device 106. In FIG. 9 is illustrated an example of the display image 200 that is displayed during the work of confirming the positions of a plurality of wireless devices. In FIG. 10 is illustrated an example of the display image 200 that is displayed after the position confirmation of all wireless devices is completed.

As illustrated in FIGS. 8 to 10, the display image 200 includes a position display 210 for indicating a plurality of device installation positions in the predetermined area and includes instruction information 220 for the instruction to confirm the position of a wireless device. The position display 210 is drawn based on the area information stored in the storage 110, and a plurality of device installation positions is expressed using icons 211, for example. Each icon 211 representing a device installation position has, for example, the “?” mark assigned thereto until a wireless device gets associated to the corresponding device installation position. In the icon 211 representing a device installation position to which a wireless device has been associated, the device ID of that wireless device is substituted for the “?” mark. Every time the position confirmation of the wireless device for which the instruction is made is completed, the instruction information 220 is updated. Moreover, the display area of the instruction information 220 doubles as a button for issuing a control instruction. Thus, when the display area of the instruction information 220 is tapped, a control instruction is issued for operating the wireless device for which the instruction to confirm the position is made with the instruction information.

Firstly, based on the confirming order list generated by the list generating unit 123, the display controller 130 decides that the wireless device having the device ID D5 (i.e., the wireless device D5) is the wireless device whose position needs to be confirmed. Then, as illustrated in FIG. 8, the display controller 130 displays, on the display device 106, the display image 200 that includes the instruction information 220 for the instruction to confirm the position of the wireless device D5.

When the display image 200 illustrated in FIG. 8 is displayed on the display device 106, the worker who refers to the display image 200 firstly taps the display area of the instruction information 220 with the aim of confirming the position of the wireless device D5. This user operation is received by the operation receiving unit 140, and a control instruction having the wireless device D5 as the destination is issued from the sending unit 150. Upon receiving the control instruction, the wireless device D5 performs predetermined operations. The worker can recognize the wireless device that, from among a plurality of wireless devices installed in the predetermined area, is performing predetermined operations as the wireless device D5 and thus can confirm the position of the wireless device D5. Herein, it is assumed that the wireless device D5 is confirmed to have been positioned at the device installation position P6.

Once it is confirmed that the wireless device D5 is positioned at the device installation position P6, the worker taps the icon 211 corresponding to the device installation position P6 in the position display 210 in the display image 200. The operation receiving unit 140 receives this user operation and associates the wireless device D5 with the device installation position P6.

Once the association of the device installation position P6 with the wireless device D5 is completed, the display controller 130 decides, based on the confirming order list generated by the list generating unit 123, that the wireless device having the device ID D4 (i.e., the wireless device D4) is the wireless device whose position needs to be confirmed. Then, the display controller 130 updates the display image 200 displayed on the display device 106 and displays, on the display device 106 as illustrated in FIG. 9, the display image 200 including the instruction information 220 for the instruction to confirm the position of the wireless device D4. In this display image 200, the icon 211 representing the device installation position P6, which is associated with the wireless device D5, is assigned with the device ID of the wireless device D5.

When the display image 200 illustrated in FIG. 9 is displayed on the display device 106, the worker who refers to the display image 200 can tap on the display area of the instruction information 220 and, in an identical manner to the earlier case of confirming the position of the wireless device D5, can operate the wireless device D4 so as to confirm the position of the wireless device D4. Herein, it is assumed that the wireless device D4 is confirmed to have been positioned at the device installation position P5. Then, the worker can tap the icon 211 corresponding to the device installation position P5 within the position display 210 in the display image 200, so that the wireless device D4 gets associated with the device installation position P5.

In the confirming work supporting device 100 according to the first embodiment, as a result of repeatedly updating of the display image as explained earlier and repeatedly receiving a user operation with respect to the display image 200, the worker can be enabled to efficiently confirm the positions of all wireless devices installed in the predetermined area, and all device installation positions in the predetermined area can be associated with wireless devices.

When the position confirmation of all wireless devices is finished and when the association of the device installation positions with the wireless devices is completed; the display controller 130 displays, on the display device 106 as illustrated in FIG. 10, for example, the display image 200 that includes a message 230 about recording the correspondence relationship of a plurality of device installation positions in the predetermined area with a plurality of wireless devices. When the worker refers to the display image 200 and taps on the display area of the message 230, the correspondence relationship of a plurality of device installation positions with a plurality of wireless devices gets finalized and is recorded as the correct correspondence relationship in the storage device 103.

As described above, in the first embodiment, the list generating unit 123 generates a confirming order list based on the correspondence relationship of a plurality of device installation positions with a plurality of wireless devices as estimated by the estimating unit 121 and based on the travelling path generated by the path generating unit 122. Then, according to the order of wireless devices given in the confirming order list, an instruction is issued for sequentially confirming the positions of the wireless devices installed in the predetermined area. In case the estimation result obtained by the estimating unit 121 is not correct, the path of movement of the worker for sequentially confirming the positions of the wireless devices according to the instruction differs from the travelling path generated by the path generating unit 122.

However, as described above, even if the estimation result obtained by the estimating unit 121 is not correct in terms of the association of individual device installation positions with individual wireless devices, the relative positional relationship among the wireless devices (for example, the relationship between neighboring wireless devices) is comparatively highly accurate. For that reason, not only the actual distance of movement of the worker does not increase by a large margin as compared to the distance of movement according to the travelling path generated by the path generating unit 122, but the actual distance of movement of the worker is also shortened by a large margin as compared to the distance of movement of the worker when confirming the positions of a plurality of wireless devices in an arbitrary order.

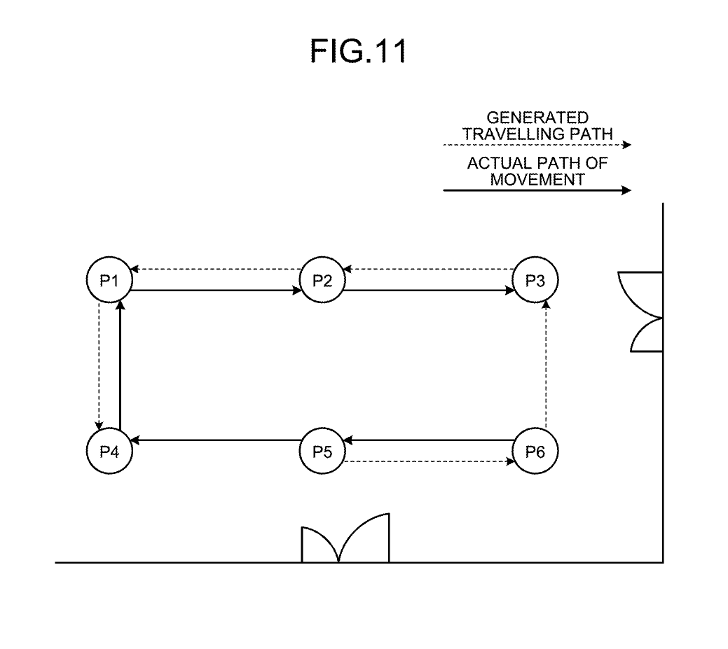

FIG. 11 is a diagram for explaining the distance of movement of the worker. In FIG. 11 is illustrated the following example: when the estimating unit 121 has estimated the correspondence relationship illustrated in FIG. 5, when the path generating unit 122 has generated the travelling path illustrated in FIG. 6, and when the list generating unit 123 has generated the confirming order list illustrated in FIG. 7; the actual path of movement of the worker is different than the travelling path generated by the path generating unit 122 because of the fact that the correspondence relationship illustrated in FIG. 5 is not correct. In FIG. 11, dashed arrows indicate the travelling path generated by the path generating unit 122, and solid arrows indicate the actual path of movement of the worker.

As illustrated in FIG. 11, even if the actual path of movement of the worker becomes different than the travelling path because of the fact that the estimation result obtained by the estimating unit 121 (i.e., the estimated correspondence relationship) is not correct, the distance of movement of the worker is equivalent to the case of following the travelling path. That is because the order of wireless devices as specified in the confirming order list corresponds to the alignment order of the device installation positions with high accuracy.

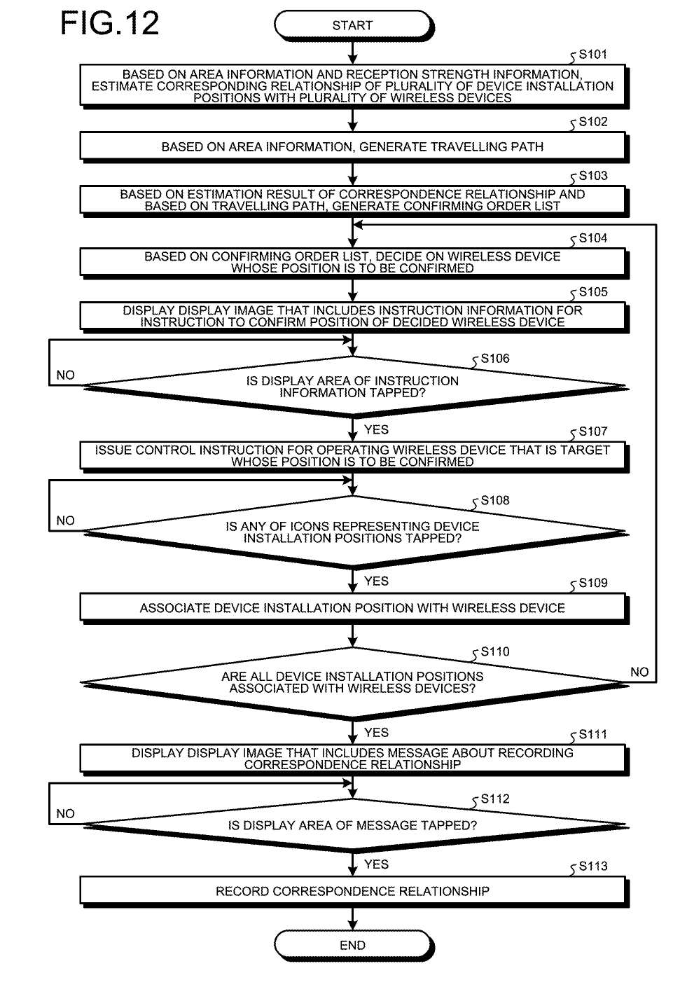

Explained below with reference to FIG. 12 are the operations performed by the confirming work supporting device 100 according to the first embodiment. FIG. 12 is a flowchart for explaining an exemplary sequence of operations performed by the confirming work supporting device 100 according to the first embodiment.

When the operations of the confirming work supporting device 100 according to the first embodiment are started, firstly, based on the area information 10 and the reception strength information 20 stored in the storage 110, the estimating unit 121 estimates the correspondence relationship of a plurality of device installation positions in a predetermined area with a plurality of wireless devices installed in the predetermined area (Step S101). Moreover, based on the area information 10 stored in the storage 110, the path generating unit 122 generates a travelling path for doing rounds of the device installation positions in an efficient manner (Step S102). A travelling path for doing rounds in an efficient manner implies, for example, the path having the shortest distance from among a plurality of paths. Meanwhile, the operations at Steps S101 and S102 can be performed in parallel, or can be performed in reverse order.

Subsequently, based on the result of estimation of the correspondence relationship as estimated at Step S101 and based on the travelling path generated at Step S102, the list generating unit 123 generates a confirming order list in which the device IDs of the wireless devices are listed according to the order in which the positions of the wireless devices need to be confirmed (Step S103).

Then, based on the confirming order list generated at Step S103, the display controller 130 decides on the wireless device whose position needs to be confirmed (Step S104). Subsequently, the display controller 130 displays, on the display device 106, the display image 200 that includes the instruction information 220 for the instruction to confirm the position of the wireless device decided at Step S104 (Step S105).

Then, a tap from a worker on the display area of the instruction information 220, which is included in the display image 200, is awaited (No at Step S106). When the display area of the instruction information 220 is tapped (Yes at Step S106), the sending unit 150 issues a control instruction for operating the wireless device that is the target whose position is to be confirmed (Step S107). As a result, the wireless device whose position is to be confirmed performs predetermined operations according to the control instruction.

Subsequently, a tap from a worker on one of the icons 211, which represent the device installation positions in the display image 200, is awaited (No at Step S108). When one of the icons 211 is tapped (Yes at Step S108), the wireless device whose position is to be confirmed is associated with the device installation position corresponding to the tapped icon 211 (Step S109).

Then, it is determined whether or not all device installation positions in the predetermined area are associated with wireless devices (Step S110). If all associations are not yet completed (No at Step S110), the system control returns to Step S104 and the subsequent operations are repeated. When all associations are completed (Yes at Step S110), the display controller 130 displays, on the display device 106, the display image 200 that includes the message 230 about recording the correspondence relationship of a plurality of device installation positions in the predetermined area with a plurality of wireless devices (Step S111).

Then, a tap from a worker on the display area of the message 230 in the display image 200 is awaited (No at Step S112). When the display area of the message 230 is tapped (Yes at Step S112), the correspondence relationship of a plurality of device installation positions with a plurality of wireless devices is recorded in the storage device 103 (Step S113). That marks the end of the sequence of operations.

Given below is the explanation of a specific example of the estimation method by which the estimating unit 121 estimates the correspondence relationship. Regarding a wireless device installed at one of a plurality of device installation positions in the predetermined area, the reception strength measured by that wireless device with respect to another wireless device is dependent on the distance between those two wireless devices, that is, dependent on the distance between the device installation positions at which those two wireless devices are installed. If dₒᵢ represents the distance between positions i and o, if d_{cons} represents a predetermined reference distance, if Rₒᵢ represents the reception strength as measured by the wireless device installed at the position i with respect to the wireless devices installed at the position o, if R_{cons} represents a predetermined reference wireless strength, if x represents the reception strength predicted from the distance (a predicted value), and if y represents the measurement-based reception strength (a measured value); then the relationship of the reception strength, which is measured by a wireless device with respect to another wireless device, with the distance between the two wireless devices can be expressed using Equations (1) to (3) given below.

$$\begin{matrix}y = x & ( 1 ) \\ x = 10 \times η \times {log}_{10} \frac{{d}_{oi}}{{d}_{cons}} & ( 2 ) \\ y = {R}_{oi} - {R}_{cons} & ( 3 )\end{matrix}$$

That is, the logarithm of the ratio of the reception strength of the wireless device installed at the position i and the reference wireless strength is proportional to the logarithm of the ratio of the distance between the positions o and i and the reference distance.

Meanwhile, due to various factors, the radio waves are subjected to multipath fading and shadowing. Hence the left side and the right side of Equation (1) are not necessary equal. In that regard, in a hypothesis h that the wireless device receiving the radio waves is installed at one of a plurality of device installation positions, the absolute value of the difference between the predicted value x and the measured value y is expressed as a degree of inconsistency c(h) as given below in Equation (4).

c(h)=|(y−x)|^{m}, under h (4)

In that case, it can be estimated that, from among the combinations of two device installation positions included in a plurality of device installation positions, in the combination of device installation positions that has a smaller degree of inconsistency c(h) than the other combinations, a wireless device that receives radio waves is installed at one device installation position and a wireless device that transmits radio waves is installed at the other device installation position. Meanwhile, in Equation (4), m represents a positive value equal to or greater than one, and is set in an arbitrary manner.

In the case in which the radio waves transmitted by the wireless device installed at the position o are received by the wireless devices installed at positions i and j; Equations (5) and (6) given below can be applied to Equation (4) instead of applying Equations (2) and (3) given earlier.

$$\begin{matrix}x = 10 \times η \times {log}_{10} \frac{{\hat{d}}_{oi}}{{\hat{d}}_{oj}} , under h & ( 5 ) \\ y = {R}_{oi} - {R}_{oj} & ( 6 )\end{matrix}$$

There, in the first embodiment, in order to estimate the correspondence relationship of a plurality of device installation positions in the predetermined area with a plurality of wireless devices installed in the predetermined area, Equation (7) given below is used in place of Equation (4).

c(h)=ΣW|(y−x)|^{m}, under h (7)

That is, the sum of the degrees of inconsistency expressed in Equation (4) is set as the degree of inconsistency c(h) of the correspondence relationship of a plurality of device installation positions with a plurality of wireless devices. Then, the correspondence relationship for which the degree of inconsistency c(h) is the smallest is estimated as the correspondence relationship of a plurality of device installation positions with a plurality of wireless devices.

As explained above with reference to a specific example, in the confirming work supporting device 100 according to the first embodiment, based on the estimation result of the correspondence relationship of a plurality of device installation devices in the predetermined area with a plurality of wireless devices installed in the predetermined area as well as based on the travelling path for doing rounds of a plurality of device installation positions in an efficient manner, a confirming order list is generated in which the device IDs of a plurality of wireless devices are listed according to the order of position confirmation of the wireless devices. Then, the wireless device whose position is to be confirmed next is decided based on the confirming order list; and the display image 200, which includes the instruction information 220 for the instruction to confirm the position of the decided wireless device, is displayed on the display device 106. Hence, the worker who performs the work of confirming the positions of a plurality of wireless devices installed in the predetermined area can refer to the display image 200 displayed on the display device 106 by the confirming work supporting device 100 and can sequentially confirm the positions of the wireless devices for which the instructions to confirm the position are made with the instruction information 220. Thus, the work of confirming the positions of a plurality of wireless devices can be performed in an efficient manner. Particularly, as compared to a case in which a worker performs the work of confirming the positions of a plurality of wireless devices in an arbitrary order, the distance of movement during the work can be shortened by a large margin.

Moreover, in the confirming work supporting device 100 according to the first embodiment, in response to a user operation performed with respect to the display image 200, a control instruction is issued to the wireless device whose position is to be confirmed and the wireless device is switched to a predetermined operating state. That enables achieving reduction in the operation load of the worker who is performing the work of confirming the positions of the wireless devices.

Furthermore, in the confirming work supporting device 100 according to the first embodiment, in response to a user operation performed with respect to the display image 200, the completion of the position confirmation of the wireless device for which the instruction is made with the instruction information 220 is recognized, and the display image 200 is updated in such a way that the instruction to confirm the position of the next wireless device is made using the instruction information 220. That enables achieving reduction in the operation load of the worker.

As described above, using the confirming work supporting device 100 according to the first embodiment, it becomes possible to support efficient implementation of the work of confirming the positions of a plurality of wireless devices installed in the predetermined area.

### First Modification Example

In the first embodiment described above, as an example of the method for estimating the correspondence relationship of a plurality of device installation positions with a plurality of wireless devices, the example is explained in which the degree of inconsistency c(h) is obtained based on the difference between the predicted value x of the reception strength, which is predicted from the distance between two positions, and the measured value y of the measurement-based reception strength. However, that is not the only possible case. Alternatively, for example, the degree of inconsistency c(h) can be obtained based on the correspondence relationship of the distance between two positions with the reception strength between the two wireless devices installed at those two positions.

Thus, if dₒᵢ represents the distance between the positions i and o and if Rₒᵢ represents the reception strength between the wireless devices installed at the positions i and o, then the degree of inconsistency c(h) can be obtained using Equations (8) to (10) given below.

x=log₁₀ dₒᵢ (8)

y=rₒᵢ, under h (9)

c(h)=correlation coefficient of (x, y), under h (10)

In this case, the sum of the degrees of inconsistency c(h) expressed using Equation (10) given above is treated as the degree of inconsistency in the correspondence relationship of a plurality of device installation positions with a plurality of wireless devices. Then, the correspondence relationship having the smallest degree of inconsistency can be estimated as the correspondence relationship of a plurality of device installation positions with a plurality of wireless devices. Herein, the correlation coefficient provides an index of measuring the strength of the linear relationship between two random variables. The correlation coefficient is a dimensionless quantity and takes a real number value equal to or greater than −1 and equal to or smaller than 1. When the correlation coefficient is positive, the random variables are said to have a positive correlation. When the correlation coefficient is negative, the random variables are said to have a negative correlation. When the correlation coefficient is zero, the random variables are said to have no correlation. Examples of the correlation coefficient include Pearson's product-moment correlation coefficient and Spearman's rank-correlation coefficient. It is possible to use any one of those correlation coefficients.

Meanwhile, the method of estimating the correspondence relationship of a plurality of device installation positions with a plurality of wireless devices is not limited to the method based on the degree of inconsistency. Alternatively, it is possible to use various other methods by which the position of a wireless device can be estimated based on the reception strength measured by the wireless device.

### Second Modification Example

In the first embodiment described above, the explanation is given about an example of generating a confirming order list based on the estimation result of the correspondence relationship of a plurality of device installation positions with a plurality of wireless devices. However, the method of generating the confirming order list is not limited to that method. Alternatively, for example, based on the reception strength information 20 stored in the storage 110, a confirming order list can be generated according to the greedy algorithm.

In the greedy algorithm, distance is used. Herein, distance implies the degree of similarity in the installation positions of two wireless devices. Explained herein are two methods for calculating the distance. In the first method, Equation (11) given below is used in calculating the distance. In Equation (11), dᵢⱼ represents the distance between two arbitrary and different wireless devices i and j, and Rᵢⱼ represents the reception strength between the wireless devices i and j.

dᵢⱼ=−Rᵢⱼ (11)

In the second method, the distribution of reception strengths is used in the calculation. As one of the methods for calculating the distribution, a method is given herein in which the calculation is performed from the distribution of reception strengths as seen from an arbitrary wireless device. More particularly, Equation (12) given below is used. In Equation (12), k represents an arbitrary wireless device, Rᵢₖ represents the reception strength between wireless devices i and k, and Rⱼₖ represents the reception strength between wireless devices j and k. Using the reception strengths Rᵢₖ and Rⱼₖ equivalent to the number of wireless devices (in Equation (12), expressed as n) installed in the predetermined area, a distance dᵢⱼ between the wireless devices i and j is calculated.

$${d}_{ij} = {\sum }_{k = 0}^{n} {( {R}_{ik} - {R}_{jk} )}^{2} \qquad ( 12 )$$

Using the distances among the wireless devices as obtained in the abovementioned manner, the greedy algorithm is implemented. Firstly, one of the wireless devices is arbitrarily selected, and the device ID of the selected wireless device is placed at the beginning of the confirming order list. Then, the wireless device having the shortest distance from the initially-selected wireless device is selected, and the device ID of the selected wireless device is placed at the second position from the beginning.

Subsequently, the wireless device having the shortest distance from the secondly-selected wireless device is selected, and the device ID of the selected wireless device is placed at the third position from the beginning. By repeating this operation for a number of times equal to the number of wireless devices installed in the predetermined area, the confirming order list can be generated.

In the case of generating the confirming order list using the greedy algorithm, neither the correspondence relationship of a plurality of device installation positions with a plurality of wireless devices needs to be estimated, nor a travelling path for efficiently doing rounds of the device installation positions needs to be generated. Hence, the confirming order list can be generated in a simpler way.

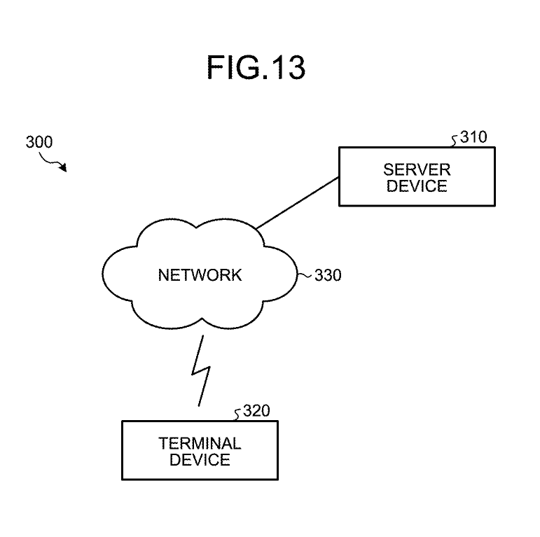

Meanwhile, in the first embodiment described above, the work of confirming the positions of the wireless devices as performed by a worker is supported by the confirming work supporting device 100 configured as a lone device. Alternatively, for example, as illustrated in FIG. 13, a confirming work supporting system 300 can be configured in which a server device 310 is communicably connected to a terminal device 320, which is in possession of a worker, via a network 330; and the server device 310 and the terminal device 320 operate in cooperation. Thus, the confirming work supporting system 300 can be used to support the work of confirming the positions of wireless devices as performed by the worker.

In that case, the storage 110, the generating unit 120, the display controller 130, the operation receiving unit 140, and the sending unit 150 can be implemented in either the server device 310 or the terminal device 320. The display controller 130 displays the display image 200 on the display device 106 of the terminal device 320, and the operation receiving unit 140 receives a user operation performed by the worker using the input device 107 of the terminal device 320.

Even in the confirming work supporting system 300 according to the third modification example, in an identical manner to the confirming work supporting device 100, it is possible to support efficient implementation of the work of confirming the positions of a plurality of wireless devices installed in the predetermined area.

### Second Embodiment

Given below is the explanation of a second embodiment. In the second embodiment, it is assumed that the predetermined area in which a plurality of wireless devices is installed is partitioned into a plurality of areas by structures such as walls. In that case, it is desirable that the work of confirming the positions of the wireless devices is performed in each partitioned area. In that regard, in the second embodiment, the wireless devices installed in the predetermined area are grouped into a plurality of groups according to the number of partitions of the predetermined area; the correspondence relationship is estimated on a group-by-group basis; and the confirming order list is generated on a group-by-group basis. Meanwhile, except for the fact that the estimating unit 121 has a grouping function, the confirming work supporting device 100 according to the second embodiment has an identical configuration to the configuration illustrated in FIG. 1. Hence, neither the configuration is again illustrated in a drawing, nor the redundant explanation is repeated.

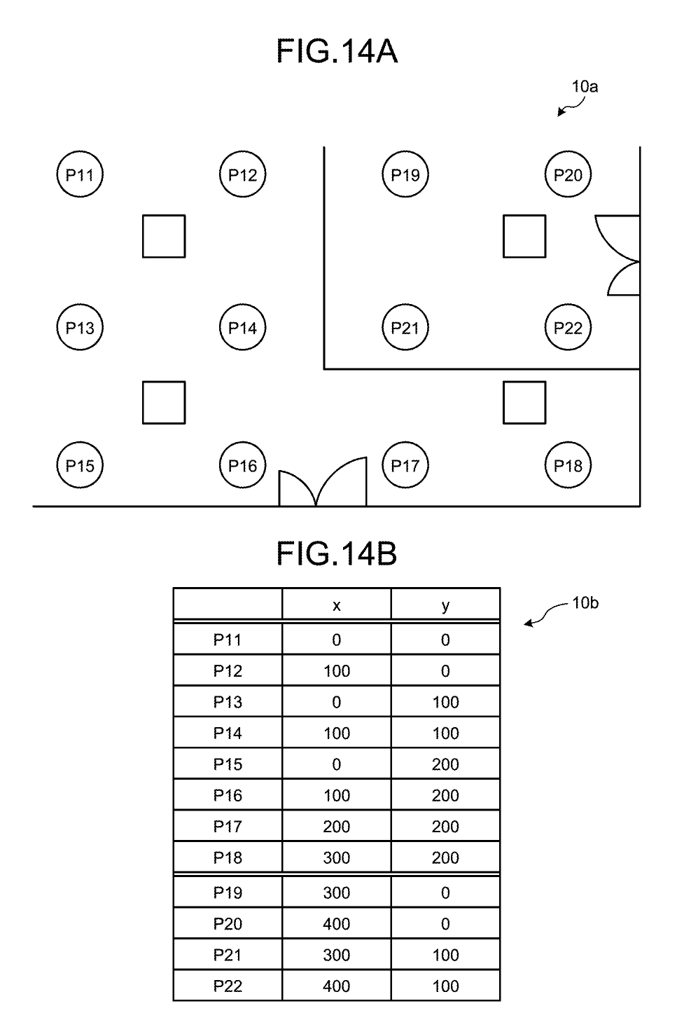

FIGS. 14A and 14B are diagrams illustrating an example of the area information 10 stored in the storage 110. In FIG. 14A is illustrated an example of the drawing data 10a of the predetermined area, and in FIG. 14B is illustrated an example of the position information table 10b. In the second embodiment, as illustrated in the area information 10 in FIGS. 14A and 14B, the predetermined area is partitioned into two areas. It is assumed that one of the two areas has eight device installation positions P11 to P18, and that the other area has four device installation positions P19 to P22.

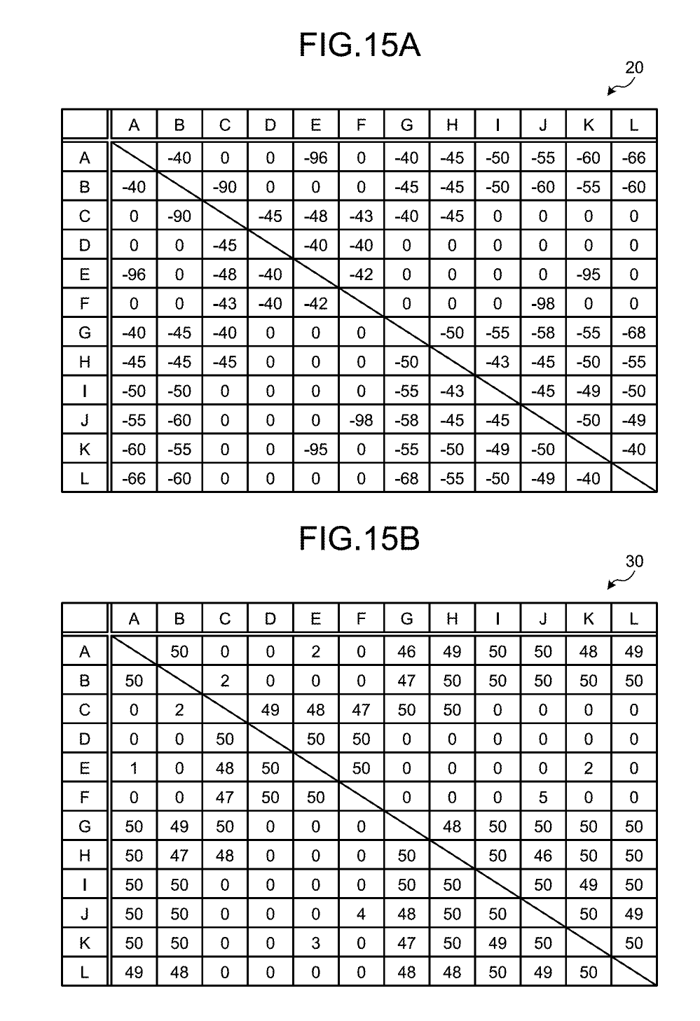

FIGS. 15A and 15B are diagrams illustrating an example of the reception strength information 20 and measurement count information 30 stored in the storage 110. In FIG. 15A is illustrated an example of the reception strength information 20, and in FIG. 15B is illustrated an example of the measurement count information 30. The reception strength information 20 illustrated in FIG. 15A is expressed as a matrix of the reception strengths with other wireless devices as measured by each of 12 wireless devices A to L (herein, A to L represent device IDs of the wireless devices) installed at one of the 12 device installation positions P11 to P22 in the predetermined area. Herein, the zero value indicates that no reception strength was measured between the two concerned wireless devices.

The measurement count information 30 illustrated in FIG. 15B is expressed as a matrix of the number of times for which the reception strength among the wireless devices could be actually measured after attempting the measurement of the reception strength for a predetermined number of times. In the example illustrated in FIG. 15B is illustrated the number of times for which the reception strength could be measured after attempting the measurement of the reception strength for 50 times. Meanwhile, in the second embodiment, although the explanation is given for an example of using the measurement count information 30 at the time of grouping a plurality of wireless devices, the groping can alternatively be done without using the measurement count information 30.

In the second embodiment, at the time of estimating the correspondence relationship of a plurality of device installation positions with a plurality of wireless devices; firstly, the estimating unit 121 groups the wireless devices based on the area information 10, the reception strength information 20, and the measurement count information 30 stored in the storage 110. For example, based on the area information 10, the estimating unit 121 identifies the number of partitions of the predetermined area and identifies the number of device installation positions in each partitioned area (i.e., the number of wireless devices installed in each partitioned area). Moreover, based on the reception strength information 20 and the measurement count information 30; the estimating unit 121 calculates, for each pair of wireless devices from among a plurality of wireless devices, a weight representing the strength of association of the two concerned wireless devices. Herein, higher the reception strength between the two wireless devices, the greater is the weight. Moreover, higher the measurement count between the two wireless signals, the greater is the weight. Then, using the identified number of partitions of the predetermined area, using the number of wireless devices installed in each partitioned area, and using the weights of the pairs of wireless devices; the estimating unit 121 implements, for example, the graph partitioning method and groups the wireless devices into a plurality of groups according to the number of partitions of the predetermined area.

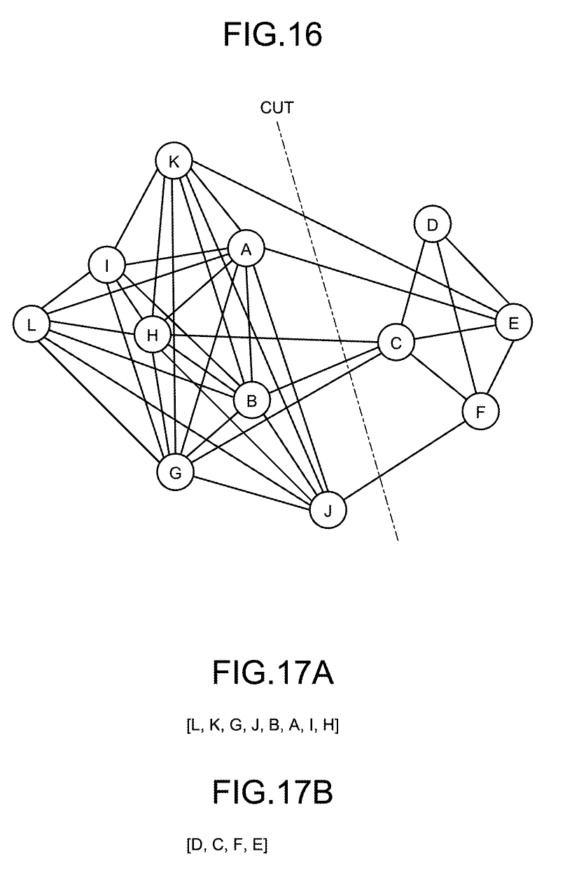

FIG. 16 is a diagram for explaining an example of the grouping performed according to the graph partitioning method. Generally, a graph is configured by joining a plurality of vertices with sides. In the second embodiment, as illustrated in FIG. 16, the device IDs of a plurality of wireless devices are assigned to the vertices of a graph. Moreover, the side joining two vertices is assigned with the weight between the corresponding two wireless devices. In the example illustrated in FIG. 16, the sides that join the two vertices corresponding to the two wireless devices whose reception strength was not measurable (i.e., the sides having the smallest weight) are not illustrated.

In the graph partitioning method, the graph is partitioned into the desired number of partitions by cutting the sides that join the vertices. At that time, the sides to be cut are decided in such a way that each partitioned graph has the desired number of vertices and that the sum of the weights of the cut sides is the smallest. In this example, since the number of partitions of the predetermined area is two and since one of the partitioned areas has eight wireless devices installed therein and the other partitioned area has four wireless devices installed therein; when the 12 wireless devices are grouped into two groups according to the graph partitioning method, a group having eight wireless devices, namely, the wireless device A, the wireless device B, and the wireless devices G to L is formed along with a group having four wireless devices C to F as illustrated in FIG. 16.

Based on the result of grouping, the estimating unit 121 estimates the correspondence relationship of a plurality of device installation positions with a plurality of wireless devices on a group-by-group basis. That is, the estimating unit 121 estimates the correspondence relationship of the eight device installation positions P11 to P18, which are present in one of the two partitioned areas of the predetermined area, with the eight wireless devices, namely, the wireless device A, the wireless device B, and the wireless devices G to L that are included in one of the two groups; as well as estimates the correspondence relationship of the four device installation positions P19 to P22, which are present in the other partitioned area, with the four wireless devices C to F included in the other group. Herein, the estimation method can be identical to the estimation method according to the first embodiment.

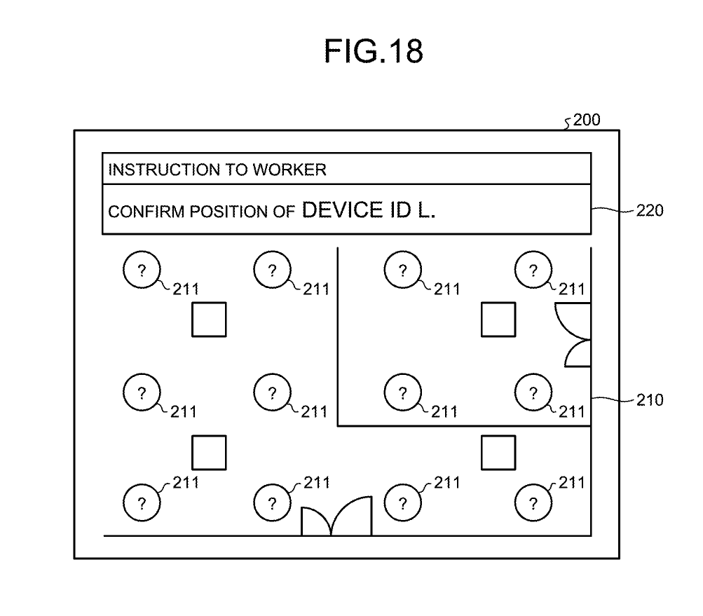

Moreover, in the second embodiment, the path generating unit 122 generates, for each partitioned area of the predetermined area, a travelling path for efficiently doing the rounds of a plurality of device installation positions in that partitioned area. Furthermore, in the second embodiment, the list generating unit 123 generates, on a group-by-group basis, a confirming order list based on the correspondence relationship estimated on a group-by-group basis by the estimating unit 121 and based on the travelling path generated for each partitioned area by the path generating unit 122. In FIGS. 17A and 17B is illustrated an example of the group-by-group confirming order lists generated in the second embodiment. In FIG. 17A is illustrated the confirming order list corresponding to the group of eight wireless devices, namely, the wireless device A, the wireless device B, and the wireless devices G to L. In FIG. 17B is illustrated the confirming order list corresponding to the group of four wireless devices C to F.

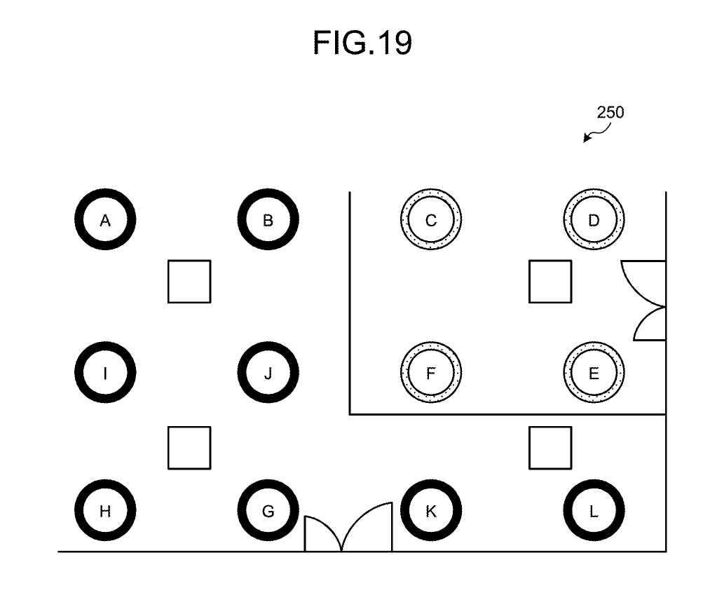

The display controller 130 according to the second embodiment sequentially uses the confirming order lists generated on a group-by-group basis by the list generating unit 123, and displays the display image 200 in an identical manner to the first embodiment on the display device 106. FIG. 18 is a diagram illustrating an example of the display image 200 displayed on the display device 106. In an identical manner to the first embodiment, the display image 200 includes the position display 210, in which a plurality of device installation positions in the predetermined area is expressed using the icons 211, and the instruction information 220 for the instruction to confirm the position of a wireless device decided based on a confirming order list. Herein, the confirming order list according to each group of wireless devices is used. That is, when the position confirmation of all wireless devices in a particular group is completed, the confirming order list to be used is changed.

As explained above with reference to a specific example, in the confirming work supporting device 100 according to the second embodiment, a plurality of wireless devices installed in the predetermined area is grouped in a plurality of groups according to the number of partitions of the predetermined area, and the correspondence relationship of a plurality of device installation positions with a plurality of wireless devices is estimated on a group-by-group basis. Then, a confirming order list is generated on a group-by-group basis, and the display image 200 is displayed on the display device 106 by sequentially using the group-by-group confirming order lists. Thus, even in the case in which the predetermined area is partitioned into a plurality of areas by structures such as walls, support can be provided to ensure that the work of confirming the positions of the wireless devices in each partitioned area is performed with efficiency. Moreover, after a plurality of wireless devices is grouped, the correspondence relationship with the device installation positions is estimated on a group-by-group basis. That enables achieving enhancement in the estimation accuracy.

### Fourth Modification Example

In the second embodiment, the display controller 130 displays, on the display device 106, the display image 200 including the position display 210 and the instruction information 220. In addition to displaying the display image 200, an estimation result display image can also be displayed on the display device 106 for the purpose of presenting to the worker the estimation result of the correspondence relationship as obtained by the estimating unit 121. At that time, the display of the display image 200 and the display of the estimation result display image can be made switchable by a predetermined operation.

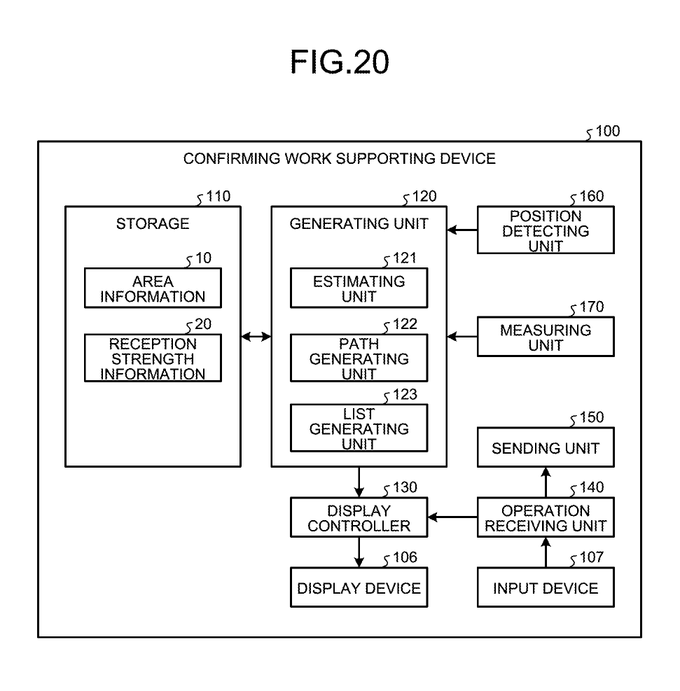

FIG. 19 is a diagram illustrating an example of an estimation result display image 250 for presenting the estimation result of the correspondence relationship to the worker. For example, as illustrated in FIG. 19, in the estimation result display image 250, at each of a plurality of device installation positions in the predetermined area, the device ID of the wireless device that is estimated to have been installed at that device installation position is displayed in an overlapping manner. Moreover, as illustrated in FIG. 19, as a reflection of the result of grouping, the display format of the device IDs of the wireless devices and the device installation positions can be varied on a group-by-group basis. Meanwhile, in a configuration in which the estimating unit 121 outputs a plurality of estimation results having different estimation accuracies, estimation result display images 250 corresponding to the estimation results can be displayed in a switchable manner on the display device 106. Moreover, the function of displaying the estimation result display image 250 is not limited to the second embodiment, and can be identically incorporated in the confirming work supporting device 100 according to the first embodiment.

As described in the fourth modification example, in a configuration in which not only the display image 200 including the position display 210 and the instruction information 220 is displayed on the display device 106, but the estimation result display image 250 is also displayed on the display device 106; for example, the worker can estimate the positions of the wireless devices by referring to the estimation result display image 250 and then proceed with the work of confirming the positions of the wireless devices according to the display image 200. With that, further efficiency in the work can be expected.

### Fifth Modification Example

In the second embodiment, grouping of a plurality of wireless devices is performed by the estimating unit 121. Alternatively, as is the case in the second modification example of the first embodiment, even when the confirming order list is generated without using the estimation result obtained by the estimating unit 121, the wireless devices can be grouped. For example, after the wireless devices are grouped using the graph partitioning method, the confirming order list can be generated on a group-by-group basis according to the greedy algorithm.

### Third Embodiment

Given below is the explanation of a third embodiment. In the third embodiment, in order to enhance the estimation accuracy of the estimating unit 121, the confirming work supporting device 100 is equipped with a function of detecting the position thereof and a function of measuring the reception strength with a plurality of wireless devices installed in the predetermined area.

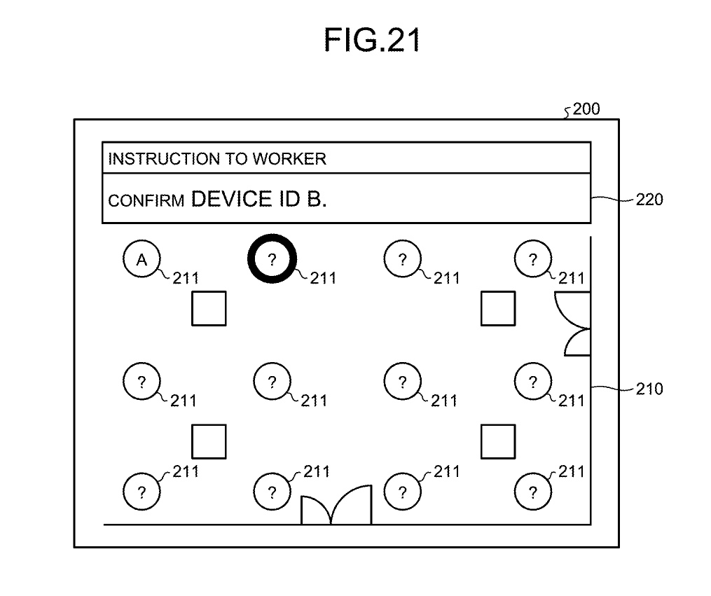

FIG. 20 is a block diagram illustrating an exemplary functional configuration of the confirming work supporting device 100 according to third embodiment. In addition to having the configuration illustrated in FIG. 1 according to the first embodiment, the confirming work supporting device 100 according to the third embodiment further includes a position detecting unit 160 and a measuring unit 170. The position detecting unit 160 detects the position of the confirming work supporting device 100. The measuring unit 170 measures the reception strength with each of a plurality of wireless devices installed in the predetermined area. Regarding the position detection method implemented by the position detecting unit 160 and the reception strength measurement method implemented by the measuring unit 170, it is possible to implement known technologies. Hence, herein, the detailed explanation is not given.

In the confirming work supporting device 100 according to the third embodiment, the estimating unit 121 estimates the correspondence relationship of a plurality of device installation positions in the predetermined area with a plurality of wireless devices, which is installed in the predetermined area, based not only on the area information 10 and the reception strength information 20 stored in the storage 110 but also on the position of the confirming work supporting device 100 as detected by the position detecting unit 160 and the reception strength with each wireless device as measured by the measuring unit 170. With that, the estimation accuracy of the estimating unit 121 can be further enhanced than the estimation accuracy achieved in the first embodiment.

The reception strength with each wireless device as measured by the measuring unit 170 is dependent on the distance between the confirming work supporting device 100 and the concerned wireless device. Since the position of the confirming work supporting device 100 is detected by the position detecting unit 160, it is possible to estimate the positional relationship of each wireless device with reference to the position of the confirming work supporting device 100. Then, using the positional relationship of each wireless device with reference to the position of the confirming work supporting device 100; for example, the degree of inconsistency that is obtained from the position information of a plurality of device installation positions in the predetermined area as well as the radio wave reception strength among the wireless devices can be adjusted, and the correspondence relationship of a plurality of device installation positions in the predetermined area with a plurality of wireless devices installed in the predetermined area can be estimated with high accuracy.

As described above, according to the third embodiment, it is possible to achieve enhancement in the estimation accuracy of the correspondence relationship of a plurality of device installation positions with a plurality of wireless devices as estimated by the estimating unit 121. Hence, it becomes possible to reduce the possibility that the efficient travelling path generated by the path generating unit 122 is different than the actual path of movement of the worker, and it thus becomes possible to enhance the efficiency of the work of position confirmation of the wireless devices.

Meanwhile, the position of the confirming work supporting device 100 as detected by the position detecting unit 160 not only can be used in the estimation of the correspondence relationship as performed by the estimating unit 121 but also can be used as, for example, information for setting the start position of the travelling path generated by the path generating unit 122. Moreover, based on the position of the confirming work supporting device 100 as detected by the position detecting unit 160, the display controller 130 can display, on the display device 106, the display image 200 on which a mark indicating the current position of the worker is displayed in an overlapping manner.

### Fourth Embodiment

Given below is the explanation of a fourth embodiment. In the fourth embodiment, using the estimation result obtained by the estimating unit 12, the device installation position at which the wireless device for which the instruction to confirm the position is made is predicted to have been installed is presented to the worker. Meanwhile, except for the fact that the display controller 130 makes use of the estimation result obtained by the estimating unit 121, the confirming work supporting device 100 according to the fourth embodiment has an identical configuration to the configuration illustrated in FIG. 1. Hence, neither the configuration is again illustrated in a drawing, nor the redundant explanation is repeated.

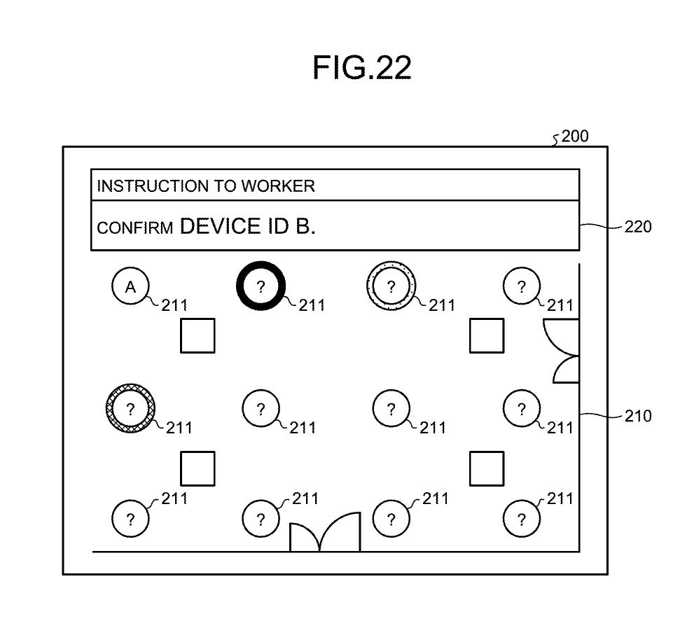

FIG. 21 is a diagram illustrating an example of the display image 200 that is displayed on the display device 106 by the display controller 130 according to the fourth embodiment. In an identical manner to the display images 200 illustrated in FIGS. 8 to 10, the display image illustrated in FIG. 21 includes the position display 210, in which the device installation positions in the predetermined area are expressed using the icons 211, and the instruction information 220, which is used for the instruction to confirm the position of the wireless device decided based on the confirming order list. Moreover, in the display image 200, regarding the device installation position at which the wireless device for which the instruction to confirm the position is made with the instruction information is predicted to have been installed, the corresponding icon 211 is displayed in a highlighted manner.

When the wireless device whose position is to be confirmed is decided based on the confirming order list, the display controller 130 refers to the estimation result obtained by the estimating unit 121 and identifies the device installation position at which the decided wireless device is predicted to have been installed. Then, as illustrated in FIG. 21, the display image 200 in which the icon 211 corresponding to the identified device installation position is highlighted is displayed on the display device 106. The worker who refers to the display image 200 can predict, in the predetermined area, the device installation position at which the wireless device for which the instruction to confirm the position is made with the instruction information 220 is installed, and thus can perform the work of confirming the positions of the wireless devices with higher efficiency.

Meanwhile, in a configuration in which the estimating unit 121 outputs a plurality of estimation results having different estimation accuracies, the display controller 130 refers to the estimation results; identifies a plurality of device installation positions at which the wireless device whose position is to be confirmed next is predicted to have been installed; and display, on the display device 106, the display image 200 in which the icons 211 corresponding to the identified device installation positions are highlighted at the degrees of highlighting according to the respective estimation accuracies. In the example of the display image 200 illustrated in FIG. 22, according to three estimation results having different estimation accuracies, three icons 211 corresponding to three device installation positions at which the wireless device whose position is to be confirmed next is predicted to have been installed are displayed in a highlighted manner at the degree of highlighting according to the estimation accuracy of the respective estimation results.

As described above, according to the fourth embodiment, on the display device 106 is displayed the display image 200 in which the icon 211 corresponding to the device installation position at which the wireless device whose position is to be confirmed in response to an instruction is predicted to have been installed. Hence, the worker can be enabled to predict the position of the wireless device whose position is to be confirmed, thereby achieving further enhancement in the efficiency of the position confirming work.

According to at least one of the embodiments described above, it is possible to support efficient implementation of the work of confirming the positions of a plurality of wireless devices installed in the predetermined area.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A confirming work supporting device comprising:
a storage configured to store therein RSSI (Received Signal Strength Indicator) information that indicates reception strength of a wireless signal as measured by each of a plurality of installed wireless devices, from another wireless device; and
processing circuitry configured to,
determine, based on the RSSI information, a confirming order in which positions of the plurality of wireless devices are to be confirmed; and
output, based on the confirming order, instruction information for an instruction to confirm a positon of a wireless device whose position is to be confirmed next.

2. The device according to claim 1, wherein the processing circuitry is further configured to,
estimate correspondence relationship of a plurality of positions of installed wireless devices, with the plurality of wireless devices based on area information containing information about the plurality of positions of installed wireless devices and based on the RSSI information;
generate, based on the area information, a travelling path for doing rounds of the plurality of positions of installed wireless devices; and
determine the confirming order based on the estimated correspondence relationship and the travelling path.

3. The device according to claim 2, wherein the processing circuitry is further configured to,
group the plurality of wireless devices into a plurality of groups,
estimate the correspondence relationship for each of the plurality of groups, and
determine the confirming order for each of the plurality of groups.

4. The device according to claim 2, further comprising:
a position detecting unit configured to detect position of the confirming work supporting device; and
a measuring unit configured to measure reception strength of a wireless signal from each of the plurality of wireless devices, wherein
the processing circuitry estimates the correspondence relationship based on the area information, the RSSI information, the position of the confirming work supporting device, and reception strengths measured by the measuring unit.

5. A confirming work supporting system comprising:
a storage configured to store therein RSSI information that indicates reception strength of a wireless signal as measured by each of a plurality of installed wireless devices, from another wireless device;
processing circuitry configured to,
determine, based on the RSSI information, a confirming order in which positions of the plurality of wireless devices are to be confirmed; and
output, based on the confirming order, instruction information for an instruction to confirm a positon of a wireless device whose position is to be confirmed next; and
a display unit configured to display a display image that includes the instruction information.

6. The system according to claim 5, wherein the processing circuitry is further configured to,
estimate correspondence relationship of a plurality of positions of installed wireless devices in an area in which the plurality of wireless devices are installed, with the plurality of wireless devices based on area information containing information about the plurality of positions of installed wireless devices and based on the RSSI information;
generate, based on the area information, a travelling path for doing rounds of the plurality of positions of installed wireless devices; and
determine the confirming order based on the estimated correspondence relationship and the travelling path.

7. The system according to claim 6, wherein
the display image includes a plurality of icons representing the plurality of positions of installed wireless devices, and
an icon corresponding to an estimated position is displayed in a highlighted manner, the estimated position representing a position of an installed wireless device at which the wireless device for which the instruction to confirm the position is made is estimated to be installed, from among the plurality of positions of installed wireless devices.

8. The system according to claim 7, wherein
the processing circuitry estimates a plurality of correspondence relationships as the correspondence relationship, and
in the display image, icons of a plurality of estimated positions corresponding to the plurality of correspondence relationships are highlighted at degrees of highlighting according to estimation accuracies of the plurality of correspondence relationships.

9. The system according to claim 5, wherein the processing circuitry further configured to receive a user operation with respect to the display image, wherein
in response to a user operation indicating completion of position confirmation of the wireless device for which the instruction is made with the instruction information, the processing circuitry updates the instruction information included in the display image.

10. The system according to claim 9, wherein
the display image includes a plurality of icons representing the plurality of positions of installed wireless devices, and
the user operation indicating completion of the position confirmation is a user operation with respect to an icon corresponding to a position of an installed wireless devices at which the wireless device for which the instruction is made with the instruction information is installed, from among the plurality of positions of installed wireless devices.

11. The system according to claim 9, the processing circuitry further configured to issue, in response to a user operation with respect to the instruction information in the display image, a control instruction to the wireless device for which the instruction to confirm the position is made.

12. A computer program product comprising a non-transitory computer readable medium including programmed instructions, the instructions causing a computer to execute:
storing RSSI information that indicates reception strength of a wireless signal as measured by each of a plurality of installed wireless devices, from another wireless device;
determining, based on the RSSI information, a confirming order in which positions of the plurality of wireless devices are to be confirmed; and
outputting, based on the confirming order, instruction information for an instruction to confirm a positon of a wireless device whose position is to be confirmed next.
